(19) United States
(12) Patent Application Publication
(10) Pub. No.: US 2026/0298409 A1
(43) Pub. Date: Oct. 1, 2026

(54) HANDLE DOCK FOR SELF-PROPELLED POOL CLEANER

(71) Applicant: ZODIAC POOL CARE EUROPE, Belberaud (FR)

(72) Inventor: Benjamin Fontanili, Belberaud (FR)

(73) Assignee: ZODIAC POOL CARE EUROPE, Belberaud (FR)

(21) Appl. No.: 19/575,223

(22) Filed: Mar. 23, 2026

Related U.S. Application Data
(60) Provisional application No. 63/779,238, filed on Mar. 27, 2025.

(51) Int. Cl. F16M 13/06; B60L 53/30; B60L 53/51; B60L 53/53; E04H 4/16; F16M 13/02

(52) U.S. Cl. CPC F16M 13/06; B60L 53/30; B60L 53/51; B60L 53/53; F16M 13/02; B60L 2200/32; E04H 4/1654

(57) ABSTRACT

A pool system includes a self-propelled pool cleaner and a handle dock for the self-propelled pool cleaner. The handle dock includes a cleaner engagement portion and an edge engagement portion. The cleaner engagement portion of the handle dock may engage the pool cleaner when the self-propelled pool cleaner is docked with the handle dock. The edge engagement portion of the handle dock may remain on an edge of a swimming pool or spa and/or may be grasped by a user to remove the pool cleaner from the swimming pool or spa.

### REFERENCE TO RELATED APPLICATION

This application claims the benefit of and priority to U.S. Provisional Patent Application No. 63/779,238, filed on Mar. 27, 2025, and entitled HANDLE DOCK FOR SELF-PROPELLED POOL CLEANER, the content of which is hereby incorporated by reference in its entirety.

### FIELD OF THE INVENTION

The invention relates to self-propelled pool cleaners for cleaning water-containing vessels such as swimming pools and spas, and more particularly to docking stations for such pool cleaners.

### BACKGROUND

Self-propelled pool cleaners capable of autonomous or semi-autonomous movement within swimming pools and spas currently exist. The most common of these devices are automatic swimming pool cleaners, which often are either hydraulic or robotic in type. Hydraulic cleaners vary water flow for movement, while robotic cleaners typically employ electric motors to cause motion. Hydraulic pool cleaners, furthermore, subdivide into “pressure-side” and “suction-side” cleaners, with pressure-side cleaners being fluidly connected to outputs of pumps of pool water circulation systems and suction-side cleaners being fluidly connected to inputs of such pumps.

When pool cleaners are not in use, they are commonly stored or positioned on a docking station. Some docking stations may be in the pool, thereby adding an extra element in the pool and/or requiring various waterproof or ingress protection ratings. Other docking stations may be outside of the pool. Regardless of where the docking station is, conventional docking stations are generally bulky and provided at a fixed location.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a handle dock for a self-propelled pool cleaner includes a cleaner engagement portion and an edge engagement portion. The cleaner engagement portion may engage the pool cleaner when the pool cleaner is docked with the handle dock. The edge engagement portion may (i) remain on an edge of a pool or spa and/or (ii) be grasped to remove the pool cleaner.

According to some embodiments, a handle dock for a self-propelled pool cleaner includes a cleaner engagement portion and an edge engagement portion. The cleaner engagement portion may engage the pool cleaner when the pool cleaner is docked with the handle dock. The edge engagement portion may be movable between a support configuration and a lifting configuration relative to the cleaner engagement portion.

According to various embodiments, a foldable handle dock for a self-propelled pool cleaner includes opposite ends and at least one docking feature for docking the pool cleaner with the foldable handle dock. The foldable handle dock is adjustable between at least two configurations such that a relative positioning of the opposite ends is adjustable.

According to some embodiments, a foldable handle dock for a self-propelled pool cleaner includes at least one docking feature for docking the pool cleaner with the foldable handle dock.

According to some embodiments, a method includes docking a self-propelled pool cleaner with a handle dock within a pool or spa and removing the pool cleaner from the pool or spa by lifting the handle dock while the pool cleaner is docked with the handle dock.

According to certain embodiments, a method includes docking a self-propelled pool cleaner with a handle dock and lowering the handle dock while the pool cleaner is docked to lower the pool cleaner into a pool or spa.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 illustrates a pool system with a handle dock according to embodiments.

FIG. 2 illustrates configurations of the handle dock of FIG. 1 according to embodiments.

FIG. 3 is another view of the pool system of FIG. 1 according to embodiments.

FIG. 4 illustrates the pool system of FIG. 1 with the handle dock including a supplemental feature according to embodiments.

FIG. 5 illustrates the pool system of FIG. 1 with the handle dock including a supplemental feature according to embodiments.

FIG. 6 illustrates the pool system of FIG. 1 with the handle dock including a supplemental feature according to embodiments.

FIG. 7 illustrates the pool system of FIG. 1 with the handle dock including a supplemental feature according to embodiments.

### DETAILED DESCRIPTION

Described herein are handle docks for pool cleaners for swimming pools and spas. In certain embodiments, the systems and methods described herein may be utilized to remove a pool cleaner from a pool or spa by removing both the handle dock and the pool cleaner. The handle docks described herein may be adjustable between various configurations for facilitating support of the handle dock on an edge of a pool or spa and/or removal of the handle dock and the pool cleaner from the pool or spa. In some embodiments, the handle docks may engage the pool cleaner when removing the pool cleaner from the pool or spa and/or placing the pool cleaner within the pool or spa. In some embodiments, the handle docks may be positioned on a pool deck when engaging the pool cleaner within the pool or spa. In some embodiments, a submerged portion of the handle may be used to engage the pool cleaner and optionally ensure submerged docking of the pool cleaner. Optionally, the handle docks described herein may include a charging system and/or a communication system.

Compared to traditional approaches, the handle docks described herein are mobile and may be quickly removed and/or positioned relative to the pool or spa. The handle docks described herein optionally may eliminate a need by a user to put their hand in water of the pool or spa for removing or deploying the pool cleaner within a pool or spa. In some embodiments, the handle docks may have a flexible configuration. In certain embodiments, the handle docks are completely removable from a pool or spa by a user while the pool cleaner is docked with the handle dock. Various other benefits and advantages may be realized with the systems, devices, and methods provided herein, and the aforementioned advantages should not be considered limiting.

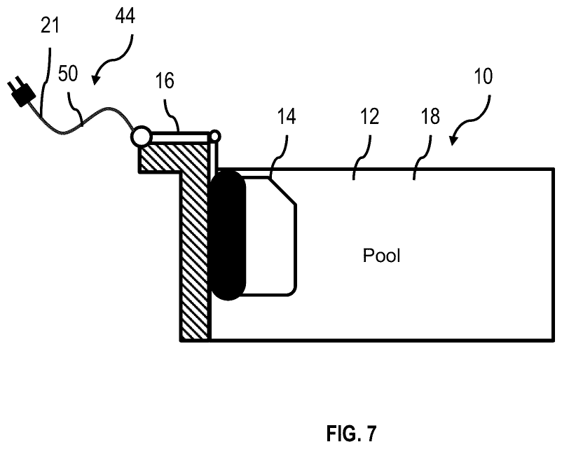

FIGS. 1-7 illustrate a pool system 10 with a pool 12, a pool cleaner 14, and a handle dock 16 according to embodiments.

The pool 12 may have various shapes, sizes, features, and configurations as desired and generally may contain a volume of water 18. In some embodiments, the pool 12 includes one or more pool walls 20 and a floor, and optionally includes one or more features such as steps, a beach, a bench, combinations thereof, and/or other features as desired.

The pool cleaner 14 is self-propelled and may be various types of cleaners capable of autonomous or semi-autonomous movement within a pool or spa. In certain embodiments, the pool cleaner 14 may be a robotic cleaner using electrical power for movement and cleaning. Additionally, or alternatively, the pool cleaner 14 may be a hydraulic cleaner utilizing water flow and/or water jets for movement.

The pool cleaner 14 may generally include a body or housing 22 with one or more inlets and one or more outlets. One or more motive elements (e.g., wheels, tracks, rollers, propellers, feet, combinations thereof, etc.) may allow or enable movement of the pool cleaner 14 within the pool 12. In some embodiments, the pool cleaner 14 may include one or more cleaning devices (including but not limited to one or more brush assemblies). A motor, a pump, a filter, a control system (processor and/or memory), and/or various other features or combinations of features may be provided on or within the pool cleaner 14 as desired. As a non-limiting example, the pool cleaner 14 may include a filter, and debris-laden water may enter the filter (e.g., from the one or more inlets), with the filter stopping or capturing at least some of the debris before allowing filtered water to exit (e.g., through the one or more outlets). In certain embodiments, the pool cleaner 14 includes an on-board power source, such as but not limited to one or more on-board batteries. Non-limiting examples of pool cleaners 14 may include those described in U.S. Pat. No. 10,316,534, U.S. Pat. No. 9,488,154, U.S. Pat. No. 8,578,538, and/or U.S. Patent Publication No. 2014/0303810, all of which are hereby incorporated by reference in their entireties.

As illustrated in FIGS. 1-7, the handle dock 16 of the pool system 10 may include a cleaner engagement portion 24 and an edge engagement portion 26. In certain embodiments, the cleaner engagement portion 24 may define a first end 30 of the handle dock 16 and the edge engagement portion 26 may define a second end 32 of the handle dock 16.

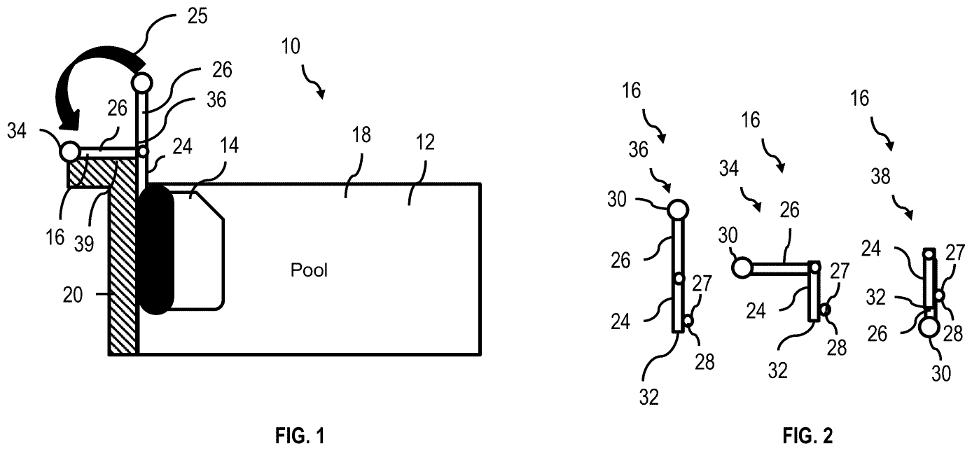

The cleaner engagement portion 24 may include one or more docking features 27 or devices suitable for engaging the pool cleaner 14 and facilitating docking of the pool cleaner 14 with the handle dock 16. As non-limiting examples, the cleaner engagement portion 24 may include hooks, clips, clasps, magnets, ridges, friction members, pins, combinations thereof, and/or other features or combinations of features as desired as the one or more docking features 27. Optionally, the docking features 27 may be actuated, although they need not be in other embodiments. In one non-limiting example, the docking feature 27 is a hook 28 (see, e.g., FIG. 2). In certain embodiments, the cleaner engagement portion 24 may be at least partially submergible within the pool 12. In certain embodiments, the docking feature 27 optionally may be configured to engage the pool cleaner 14 such that the pool cleaner 14 is movable with the handle dock 16. As a non-limiting example, the docking feature 27 may engage the pool cleaner 14 such that the pool cleaner 14 is vertically positionable and/or maneuverable with the handle dock 16.

The edge engagement portion 26 is movable relative the cleaner engagement portion 24 and may be utilized for engaging an edge of the pool 12 and/or for handling by a user. In certain embodiments, and as illustrated in FIG. 1, the edge engagement portion 26 is pivotable or otherwise movable relative to the cleaner engagement portion 24 (represented by arrow 25) such that the edge engagement portion 26 includes one or more configurations relative to the cleaner engagement portion 24. In one non-limiting example, the edge engagement portion 26 is pivotable relative to the cleaner engagement portion 24. As a non-limiting example, and as illustrated in FIG. 2, the edge engagement portion 26 is adjustable relative to the cleaner engagement portion 24 such that the edge engagement portion 26 includes a support configuration 34, a lifting configuration 36, and/or a folded configuration 38, and/or various other configurations as desired.

In some embodiments, the one or more configurations include the edge engagement portion 26 at different angles relative to the cleaner engagement portion 24. As a non-limiting example, in the support configuration, the edge engagement portion 26 may be at a first angle relative to the cleaner engagement portion 24, and wherein, in the lifting configuration, the edge engagement portion 26 may be at a second angle relative to the cleaner engagement portion 24. In a non-limiting example, the first angle is a non-zero angle. In a non-limiting example, the first angle is 90°, although in other embodiments, the first angle may be an acute angle or an obtuse angle as desire. In a further non-limiting example, the second angle may be a zero angle. Other configurations may have other relative angles between the edge engagement portion 26 and the cleaner engagement portion 24 as desired.

Optionally, the handle dock 16 may include various locking features for locking the edge engagement portion 26 in a desired configuration relative to the cleaner engagement portion 24, although locking features may be omitted in other embodiments. Non-limiting examples of locking features include clips, clasps, stoppers, friction-fit or snap-fit mechanisms, pins, hooks, fasteners, magnets, combinations thereof, and/or other features or combinations of features as desired.

In some embodiments, the handle dock 16 includes at least the support configuration 34 and the lifting configuration 36. As discussed in detail below, the support configuration 34 may facilitate support of the handle dock 16 on the edge of the pool 12, and the lifting configuration 36 may facilitate gripping by a user for removing and/or deploying the pool cleaner 14 within the pool 12. Optionally, in the support configuration 34, the edge engagement portion 26 may extend generally perpendicular to the cleaner engagement portion 24, although in other embodiments the edge engagement portion 26 may be at other angles relative to the cleaner engagement portion 24 as desired.

As illustrated in FIG. 2, in some embodiments, the handle dock 16 may be pivotable into various other configurations as desired. As a non-limiting example, as illustrated in FIG. 2, the handle dock 16 may be pivotable to the folded configuration 38. In these embodiments and as illustrated in FIG. 2, in the lifting configuration 36, the ends 30, 32 generally may be opposite from each other, in the support configuration 34, the ends 30, 32 may be offset relative to each other, and in the folded configuration 38, the ends 30, 32 may be proximate to each other. Other configurations may be implemented as desired, and the edge engagement portion 26 may be at other orientations relative to the cleaner engagement portion 24 as desired.

Referring back to FIG. 1, for example, in the support configuration 34, the edge engagement portion 26 of the handle dock 16 may engage an edge 39 of the pool 12. Optionally, when the handle dock 16 is in the support configuration 34 on the edge 39 of the pool 12, the edge engagement portion 26 may position the cleaner engagement portion 24 such that the cleaner engagement portion 24 is at least partially submerged within the pool 12. In some embodiments, when the handle dock 16 is in the support configuration 34 on the edge 39 of the pool 12, the edge engagement portion 26 may position the cleaner engagement portion 24 such that the pool cleaner 14 docked with the cleaner engagement portion 24 is at least partially submerged (and optionally fully submerged) within the pool 12.

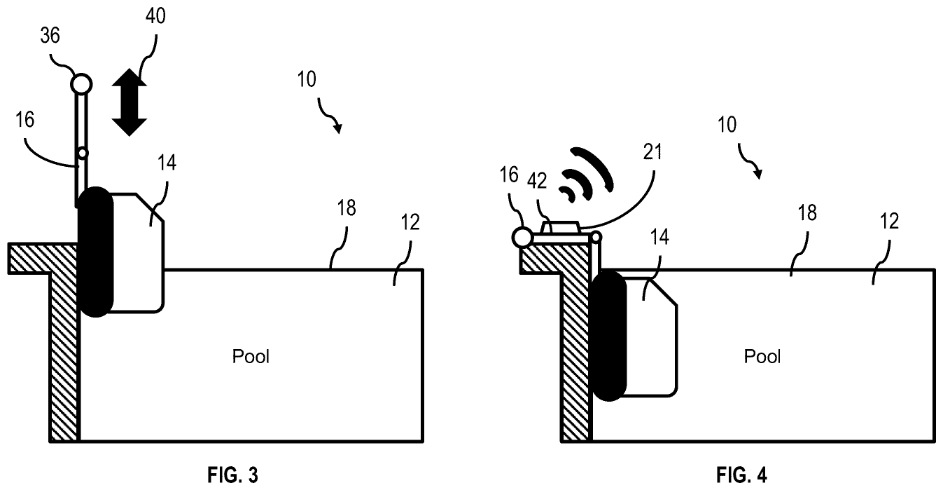

Referring to FIGS. 1 and 3, in the lifting configuration 36, the edge engagement portion 26 may be positioned relative to the cleaner engagement portion 24 to facilitate access and/or grasping by a user for maneuvering the handle dock 16 (and optionally the pool cleaner 14). As a non-limiting example, the handle dock 16 in the lifting configuration 36 may facilitate vertical maneuvering of the handle dock 16 (and optionally the pool cleaner 14) as represented by arrow 40 in FIG. 3., such as lifting and/or lowering the handle dock 16. In certain embodiments, in the lifting configuration 36, the handle dock 16 may be lifted or lowered while the pool cleaner 14 remains docked with the handle dock 16. In this regard, lifting the handle dock 16 may lift both the handle dock 16 and the pool cleaner 14, thereby facilitating removal of the pool cleaner 14 and/or positioning of the pool cleaner 14 and the handle dock 16 as desired. Conversely, lowering the handle dock 16 may lower both the handle dock 16 and the pool cleaner 14, thereby facilitating positioning and/or insertion of the pool cleaner 14 into the pool 12.

Referring to FIGS. 4-7, in various embodiments, the handle dock 16 optionally may include one or more supplemental features 21 as desired. The supplemental features 21 may be various types of features as desired, such as but not limited to features facilitating and/or improving engagement with the pool cleaner 14, features facilitating and/or improving interaction with the pool cleaner 14, and/or features providing improved functionality to the handle dock 16. Non-limiting examples are discussed in greater detail below with reference to FIGS. 4-7. Moreover, while supplemental features 21 are illustrated individually, a handle dock 16 may include a plurality of supplemental features 21 as desired, and in such cases, the supplemental features 21 may be a same type or a different type of supplemental feature 21 as desired.

In some embodiments, and as illustrated in FIG. 4, the handle dock 16 optionally includes a communications system 42 as a supplemental feature 21. In such embodiments, the communications system 42 may enable communication between the handle dock 16 and a remote device or system via various wired or wireless communication as desired (e.g., near field, cellular, WiFi, LoRa, Bluetooth®, Bluetooth Low Energy (BLE), low-power wide area network, cloud-based communication, etc.). Additionally, or alternatively, the communications system 42 may enable communication with the pool cleaner 14. In a non-limiting example, the communications system 42 may facilitate LiFi communication with the pool cleaner 14. In some optional embodiments, the communications system 42 may be a communications relay facilitating communication between the pool cleaner 14 to a remote device or system, optionally using different communications techniques depending on whether the communication is between the communications system 42 and the pool cleaner 14 or between the communications system 42 and the remote device or system.

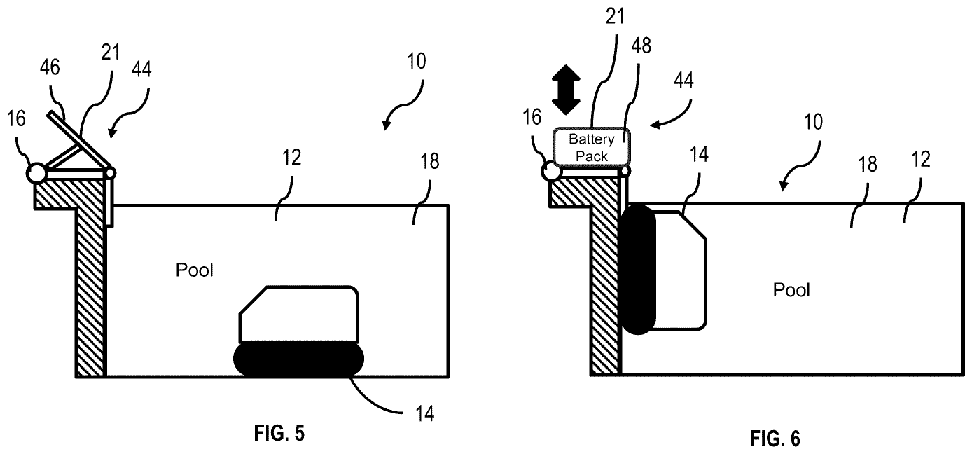

With reference to FIGS. 5-7, additionally, or alternatively, the handle dock 16 optionally may include a charging system 44 as the supplemental feature 21. The charging system 44 may be utilized for charging and/or re-charging an onboard battery of the pool cleaner 14 when the pool cleaner 14 is docked with the handle dock 16. The charging system 44 may include features for contact charging (e.g., charging pins or contacts) and/or contactless charging (e.g., via induction) of the pool cleaner 14 as desired. In certain embodiments, the features for charging of the charging system 44 may include features suitable for charging the pool cleaner 14 while the pool cleaner 14 is at least partially submerged.

In some embodiments, the charging system 44 may include various features for utilizing various sources of power to charge and/or re-charge the pool cleaner 14. As non-limiting examples, the charging system 44 may include one or more solar panels 46 (FIG. 4), one or more removable recharging batteries 48 (FIG. 6), and/or a cord 50 for obtaining power from an external power supply. Various other features or combinations thereof may be utilized as desired, and the aforementioned examples should not be considered limiting.

As mentioned, the handle docks described herein provide improved operation for a user and improved engagement with a pool cleaner. In certain cases, the handle docks are mobile and may be quickly removed and/or positioned relative to the pool or spa. Various other benefits and advantages may be realized with the systems, devices, and methods provided herein, and the aforementioned advantages should not be considered limiting.

Exemplary concepts or combinations of features of the invention may include:
A. A handle dock for a self-propelled pool cleaner, the handle dock comprising a cleaner engagement portion and an edge engagement portion, the cleaner engagement portion configured to engage the pool cleaner when the pool cleaner is docked with the handle dock, and the edge engagement portion configured to (i) remain on an edge of a pool or spa and/or (ii) be grasped to remove the pool cleaner from the pool or spa.
B. The handle dock of any preceding or subsequent statement or combination of statements, wherein the edge engagement portion is pivotable relative to the base portion.
C. The handle dock of any preceding or subsequent statement or combination of statements, wherein the handle dock further comprises at least one supplemental feature.
D. The handle dock of any preceding or subsequent statement or combination of statements, wherein the at least one supplemental feature comprises a charging system for charging the pool cleaner.
E. The handle dock of any preceding or subsequent statement or combination of statements, wherein the charging system comprises at least one of a solar panel, a removable battery, or a cord.
F. The handle dock of any preceding or subsequent statement or combination of statements, wherein the at least one supplemental feature comprises a communications system.
G. The handle dock of any preceding or subsequent statement or combination of statements, wherein the cleaner engagement portion is at least partially submergible in a pool or spa.
H. The handle dock of any of any preceding or subsequent statement or combination of statements, wherein, when the handle dock is supported on the edge of the pool or spa, the cleaner engagement portion is configured to engage the pool cleaner such that the pool cleaner is submerged when the pool cleaner is docked with the handle dock.
I. The handle dock of any of any preceding or subsequent statement or combination of statements, wherein the cleaner engagement portion includes at least one docking feature for engaging the pool cleaner.
J. The handle dock of any of any preceding or subsequent statement or combination of statements, wherein the at least one docking feature comprises at least one of a hook, a clip, a clasp, a magnet, a ridge, a friction member, or a pin.
K. The handle dock of any of any preceding or subsequent statement or combination of statements, wherein the at least one docking feature is configured to engage the pool cleaner such that the pool cleaner is movable with the handle dock.
L. A handle dock for a self-propelled pool cleaner, the handle dock comprising a cleaner engagement portion and an edge engagement portion, wherein the cleaner engagement portion is configured to engage the pool cleaner when the pool cleaner is docked with the handle dock, and wherein the edge engagement portion is movable between a support configuration and a lifting configuration relative to the cleaner engagement portion.
M. The handle dock of any preceding or subsequent statement or combination of statements, wherein, in the support configuration, the edge engagement portion is at a first angle relative to the cleaner engagement portion to engage an end of a pool or spa while at least partially submerging the cleaner engagement portion, and wherein, in the lifting configuration, the edge engagement portion is at a second angle relative to the cleaner engagement portion for removing the handle dock from the pool or spa.
N. The handle dock of any preceding or subsequent statement or combination of statements, wherein the first angle is a non-zero angle.
O. The handle dock of any preceding or subsequent statement or combination of statements, wherein the first angle is 90°.
P. The handle dock of any preceding or subsequent statement or combination of statements, wherein the second angle is a zero angle.
Q. A foldable handle dock for a self-propelled pool cleaner, the foldable handle dock comprising at least one docking feature for docking the pool cleaner with the foldable handle dock.
R. A foldable handle dock for a self-propelled pool cleaner, the foldable handle dock comprising opposite ends and at least one docking feature for docking the pool cleaner with the foldable handle dock, wherein the foldable handle dock is adjustable between at least two configurations such that a relative positioning of the opposite ends is adjustable.
S. The foldable handle dock of any preceding or subsequent statement or combination of statements, wherein, in a first configuration of the at least two configurations, the opposite ends are spaced apart, and in a second configuration of the at least two configurations, the opposite ends are proximate to each other.
T. A method comprising:
   i. docking a self-propelled pool cleaner with a handle dock within a pool or spa; and
   ii. lifting the handle dock while the pool cleaner is docked with the handle dock to remove the pool cleaner from the pool or spa.
U. A method comprising:
   i. docking a self-propelled pool cleaner with a handle dock; and
   ii. lowering the handle dock while the pool cleaner is docked to lower the pool cleaner into a pool or spa.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with pool cleaners, persons skilled in the relevant field will recognize that the present invention conceivably could be employed in connection with other objects and in other manners. Finally, references to “pools” and “swimming pools” herein may also refer to spas or other water containing vessels used for recreation, training, or therapy and for which cleaning of debris is needed or desired.

As used herein, the meaning of “a,” “an,” and “the” includes singular and plural references unless the context clearly dictates otherwise.

The subject matter of embodiments of the present disclosure is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. A zero angle refers to an angle of 0°or 180°. Directional references such as “up,” “down,” “top,” “bottom,” “left,” “right,” “vertical,” “horizontal,” “lateral,” “longitudinal,” “front,” and “back,” among others, are intended to refer to the orientation as illustrated and described in the figure (or figures) to which the components and directions are referencing.

The terms “comprising,” “having,” “including,” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention, and does not pose a limitation on the scope of the invention unless otherwise claimed. No language in the specification should be construed as indicating any non-claimed element as essential to the practice of the invention.

The above-described aspects are merely possible examples of implementations, merely set forth for a clear understanding of the principles of the present disclosure. Many variations and modifications can be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described embodiments, nor the claims that follow.

That which is claimed:

1. A handle dock for a self-propelled pool cleaner, the handle dock comprising:
a cleaner engagement portion; and
an edge engagement portion,
wherein the cleaner engagement portion configured to engage the pool cleaner when the pool cleaner is docked with the handle dock, and
wherein the edge engagement portion configured to (i) remain on an edge of a pool or spa and/or (ii) be grasped to remove the pool cleaner.

2. The handle dock of claim 1, wherein the edge engagement portion is pivotable relative to the cleaner engagement portion.

3. The handle dock of claim 1, wherein the cleaner engagement portion is at least partially submergible in a pool or spa.

4. The handle dock of claim 1, wherein the handle dock further comprises at least one supplemental feature.

5. The handle dock of claim 4, wherein the at least one supplemental feature comprises a charging system for charging the pool cleaner.

6. The handle dock of claim 5, wherein the charging system comprises at least one of a solar panel, a removable battery, or a cord.

7. The handle dock of claim 4 wherein the at least one supplemental feature comprises a communications system.

8. The handle dock of claim 1, wherein, when the handle dock is supported on an edge of the pool or spa, the cleaner engagement portion is configured to engage the pool cleaner such that the pool cleaner is submerged when the pool cleaner is docked with the handle dock.

9. The handle dock of claim 1, wherein the cleaner engagement portion includes at least one docking feature for engaging the pool cleaner.

10. The handle dock of claim 9, wherein the at least one docking feature comprises at least one of a hook, a clip, a clasp, a magnet, a ridge, a friction member, or a pin.

11. The handle dock of claim 9, wherein the at least one docking feature is configured to engage the pool cleaner such that the pool cleaner is movable with the handle dock.

12. A handle dock for a self-propelled pool cleaner, the handle dock comprising:
a cleaner engagement portion; and
an edge engagement portion,
wherein the cleaner engagement portion is configured to engage the pool cleaner when the pool cleaner is docked with the handle dock, and
wherein the edge engagement portion is movable between a support configuration and a lifting configuration relative to the cleaner engagement portion.

13. The handle dock of claim 12, wherein, in the support configuration, the edge engagement portion is at a first angle relative to the cleaner engagement portion to engage an end of a pool or spa while at least partially submerging the cleaner engagement portion, and wherein, in the lifting configuration, the edge engagement portion is at a second angle relative to the cleaner engagement portion for removing the handle dock from the pool or spa.

14. The handle dock of claim 13, wherein the first angle is a non-zero angle.

15. The handle dock of claim 14, wherein the first angle is 90°.

16. The handle dock of claim 13, wherein the second angle is a zero angle.

17. A foldable handle dock for a self-propelled pool cleaner, the foldable handle dock comprising opposite ends and at least one docking feature for docking the pool cleaner with the foldable handle dock, wherein the foldable handle dock is adjustable between at least two configurations such that a relative positioning of the opposite ends is adjustable.

18. The foldable handle dock of claim 17, wherein, in a first configuration of the at least two configurations, the opposite ends are spaced apart, and in a second configuration of the at least two configurations, the opposite ends are proximate to each other.

19. The foldable handle dock of claim 17, wherein the at least one docking feature is configured to engage the pool cleaner such that the pool cleaner is movable with the handle dock.

20. The foldable handle dock of claim 17, further comprises at least one supplemental feature.
